(19) United States
(12) Patent Application Publication
(10) Pub. No.: US 2003/0171945 A1
(43) Pub. Date: Sep. 11, 2003

(54) Knowledge system and methods of business alerting and business analysis

(76) Inventor: Wilko Juurt Jan Kuiper, Bedum (NL)

Correspondence Address: MICHAELSON AND WALLACE, PARKWAY 109 OFFICE CENTER, 328 NEWMAN SPRINGS RD, P O BOX 8489, RED BANK, NJ, 07701

(21) Appl. No.: 10/240,837

(22) PCT Filed: Apr. 5, 2001
(86) PCT No.: PCT/EP01/04012

(30) Foreign Application Priority Data
Apr. 5, 2000 (EP) 002012276
Apr. 5, 2000 (US) 60194360

(51) Int. Cl. G06F 17/60

(52) U.S. Cl. 705/1

(57) ABSTRACT

A knowledge system compiled on a computer environment or a memory carrier is disclosed. The knowledge system coupled information about one or more business processes or functions no one or more software and hardware components stored in the computer environment. The knowledge system providers information about the impact on business processes or functions towards a user interface in case of an erroneous operation of the software and hardware components.

### FIELD OF THE INVENTION

The present invention relates to knowledge or expert systems and to methods of business processing. More in particular a novel computer knowledge system and novel methods of business processing making use of knowledge relations are disclosed.

### BACKGROUND OF THE INVENTION

Knowledge or expert systems are known in the art. An example of such a system is the Service Assurance Center system, commercially provided by the company BMC Software, the publicly available information about this system being incorporated herein by reference. The Service Assurance Center provides Information Technology organizations a view of:

how services are performing;

whether services am available at any given moment around the world; and

how both its internal staff and external customers are using its application services.

The Service Assurance Center system is monitoring Information Technology (IT) systems, including software application parts, and the technical infra Structure (IS), including hardware components. This monitoring is executed by synthetic transactions wherein, for example, a Personal Computer emulates the behavior of a user. Hereby information can be gathered whether and to what extent parts of the IT systems are correctly working or are correctly emulating a physical infrastructure.

In an article by Lewis, L, et al., “Incorporating Business Process Management into Network and Systems Management”, Proceedings—ISADS 97—Third International Symposium on Autonomous Decentralized Systems (Cat. No. 97TB100111), Proceedings of the International Symposium on Autonomous Decentralized Systems, ISADS 97, Los Alamitos, Calif., USA, IEEE Comput. Soc. Press, USA, page(s) 385-392, an approach towards autonomous, decentralized monitoring and management of Business Processes (BP) is disclosed.

To realize BP management, existing techniques in integrated network and systems management are employed. The system is made up of agents, among others an alarm monitoring agent, who's responsibility is to collect and forward alarms of the operation of hardware and software components used in a computer environment operative for enabling a plurality of business processes, a reasoning agent for correlating alarms, and an alarm notification agent displaying alarms concerning BP to users, for taking corrective actions manually or automatically.

The system disclosed correlates business processes or functions to changes or disturbances in the IT system, i.e. the software components, as well as to the IS system parts, i.e. the hardware components, making up the computer environment.

### PROBLEM DEFINITION AND AIM OF THE INVENTION

The prior art knowledge or expert systems disclosed above just provide a tool for controlling and/or managing the IT/IS systems being part of a business and for correlating business processes or functions to changes or disturbances in the IT/IS system.

In practice, business processes or functions are associated with one another, such that malfunctioning of one or a few of the business processes, for example, can have a tremendous impact on the operation or execution of other business processes or functions, either directly or indirectly enabled by the computer environment.

In a telecommunications network, for example, failure of a switch may not only involve the call processing of that particular switch, but also payment transactions and other vital data transactions, on a local or even global scale.

There is a further problem in the art in that the IT/IS systems that are developed to manage or monitor the business processes or functions are becoming more and more complex. Therefore it is difficult to analyze the impact of functional errors in parts of the IT/IS systems in relation to the performance of the system as a whole. Prior art solutions do not tackle this problem to a sufficient level.

Accordingly, there is a need to provide a knowledge system that not only communicates about a single or a few business processes in terms of its or their relation to the performance of the underlying IT/IS system, but also on how the operation of affected business processes influence the operation or execution of other business processes of the computer system.

### SUMMARY OF THE INVENTION

In accordance with a first aspect of the present invention, there is provided a computer knowledge system, for operation in a computer environment using a plurality of hardware and software components operatively arranged for enabling a plurality of business processes, the computer knowledge system comprises

a monitoring agent, arranged for collecting data providing information about the operation of the hardware and software components;

a relational database, storing data providing information about the operation of the business processes and error data relating to erroneous operation of the hardware and software components; and

a user interface, arranged for providing information about the operation of the business processes using the data collected by the monitoring agent and the data stored in the relational database,

the relational database being arranged for providing information towards the user interface about the impact on the operation of the business processes of an erroneous operation of the hardware and software components.

The knowledge system according to the present invention couples information about one or more business processes or functions to one or more software and hardware components used in the computer environment, while the knowledge system provides information about the impact on the execution of business processes or functions towards a user interface in case of erroneous operation of the software and hardware components.

The software and hardware components can include all kind of Information Technology infrastructures known to the person of skill in the art, including network connections, files, database, and software applications. The software components furthermore can be coupled to the physical infrastructure on which the business processes or functions are based.

The business processes or functions may include, for example, a business process communication, such as a fixed-telephone telecommunication connection, and may include the IT system including the operating system and IS hardware of the business process and the network connections of the telephone network.

In the case of a the above telecommunications system, for example, with the present invention, failure of a switch will not only be reported as to affecting the call processing of that switch but also as to the impact thereof to other business processes, such as the financial transactions handled through this switch.

Thus, the business processes or functions information provided by the present invention are broader than setting up a one-to-one connection between an error identification in a software component and a corresponding troubleshooting message to a user interface, while the information is provided in the “language” of the business processes.

The business process or functions, for example, can also include financial processes such as investment funds management or financial transaction business processes or production installation processes such as the actual production processes in a chemical plant or for car manufacturing. The business processes or functions are automated an preferably integrated business processes or functions with a complexity of individual business steps that are related one to the other.

In a further embodiment of the computer knowledge system according to the present invention, the relational database comprises data identifying functional transactions within the business processes and dependencies between functional transactions within business processes, wherein the user interface is arranged for correlating the error data and the functional transactions data for providing the information about the impact on the business processes of an erroneous operation of the hardware and software components.

The coupling of information about one or more business processes or functions to one or more software and hardware components can be done in several ways. The coupling can include a correlation between one or more business processes or functions to one or more software components and/or include a straightforward link with a number of call-in procedures between one or more business processes or functions to one or more software and hardware components. At least part of the coupled information can be stored in the relational database or stored on the computer environment. The relational database for example can be based on ACCESS, or can be based on database software provided by ORACLE, SYBASE; or SEQUEL SERVER or any other relational database software known to the person of skill in the art.

A main purpose of the computer knowledge system according to the present invention is a goal-oriented processes control. To this end, in a yet further embodiment of the system according to the invention, the user interface is arranged for providing the information about the business processes indicating at least one of a group comprising:

the extent to which business processes are influenced by a disturbance in the software and hardware components;

the extent to which business processes are influenced by a functional error in the hardware and software components;

the extent to which business processes are influenced by a functional error in the hardware and software components, which functional error cannot directly be monitored;

the extent to which business processes are influenced by an externally applied change, such as a predetermined change for performing impact analyses, in the hardware and software components; and

the extent to which business processes are available in the case of an erroneous operation of the hardware and software components.

The information provided can benefit from historical data about erroneous operation of the hardware and software components. To this end, in accordance with an other embodiment of the computer knowledge system of the invention, the system comprises a historical database, storing historical data about erroneous operation of the hardware and software components and the impact thereof on the business processes, wherein the user interface is arranged for providing the information about the impact on the business processes of an erroneous operation of the hardware and software components using the historical data.

Business process monitoring and business process control generally involves several user groups, both internally and externally of the computer environment on which the business processes are internally or externally executed. The several user groups have different requirements as to the type and presentation of the relevant information.

Accordingly, in a still further embodiment of the computer knowledge system according to the present invention, the user interface is arranged for providing the information about the impact on the enabling of the business processes of an erroneous operation of the hardware and software components in a predetermined format adapted to the user of the information.

In a more detailed embodiment, the computer knowledge system according to the present invention is arranged for providing the information relevant to the different user groups in terms of:

functionality of the business processes;

usability of the business processes;

maintainability of the business processes;

efficiency of the business processes;

reliability of the business processes; and

changeability of the business processes.

The coupling of information about one or more business processes or functions to one or more software and hardware components can be done in several ways. The coupling can include a correlation between one or more business processes or functions to one or more software components and or may include a straightforward link with a number of call-in procedures between one or more business processes or functions to one or more software and hardware components. At least part of the coupled information can be stored in the relational database which stored on said computer environment.

In a further embodiment of the system according to the invention, the monitoring agent, the relational database and the user interface connect through a central agent, among orders, providing processing support.

The user interface can be part of the computer environment, but the user interface can also be external to the computer environment and be linked by a communication channel to the knowledge system. The user interface can be a computer screen, a mobile telephone, or a flat panel or whatever user interface suitable for the purpose of the present invention and known to the person of skill in the art. The user interface can also include the World-Wide-Web internet or intranet infrastructure.

The information to be collected about the operation of the hardware and software components, is in a further embodiment of the invention, acquired in that the monitoring agent is arranged for collecting:

workflow data provided by the computer environment;

system monitoring data; and

data accumulated in a data warehouse of the computer environment.

Data accumulated in a data warehouse will, in general, have a low topicality. Workflow data are acquired using an automated Workflow Management System (WMS) or ERP system or systems. System monitoring data is collected on-line from the infrastructure or derived from IT application and system monitoring.

In a prefered embodiment of the invention, the monitoring agent comprises a knowledge module, operating with a business flow monitor and a component monitor for collecting data providing information about the operation of the business processes and the hardware and software components.

The knowledged module, in a yet further embodiment of the computer knowledge system of the invention, is arranged for collecting data with respect to:

availability of critical components;

communications performance between critical components;

critical messages in application and system log files;

synthetic transaction from end user view;

application and system processes;

database and critical table(s) data availability; and

system resource availability and performance.

The user interface may be arranged for providing information on an automated basis or on a subscription basis, for example by issuing notification messages, standard reports, as an HTML (Hyper Text Markup Language) page and in a form of a trouble ticket. Further, in accordance with the present invention, the information towards the user interface, in order to reduce the information flow, may be provided if the impact on the execution of the business processes exceeds a predeterminated threshold value.

In a second aspect of the present invention, a method of providing information or alerting about the operation of business processes in a computer environment using a plurality of hardware and software components operatively arranged for enabling a plurality of business processes, the method comprises:

collecting data providing information about the operation of the hardware and software components;

storing data providing information about the operation of the business processes and error data relating to erroneous operation of the hardware and software components; and

providing information towards a user interface about the operation of the business processes using the collected and stored data,

the data are processed for providing information towards the user interface about the impact on the enabling of the business processes of an erroneous operation of the hardware and software components.

In a third aspect of the present invention, there is provided a method of analyzing the operation of business processes in a computer environment using a plurality of hardware and software components operatively arranged for enabling a plurality of business processes, the method comprises:

collecting data providing information about the operation of the hardware and software components;

storing data providing information about the operation of the business processes and error data relating to erroneous operation of the hardware and software components; and

providing information towards a user interface about the operation of the business processes using the collected and stored data,

the data are processed for providing information towards the user interface about the impact on the enabling of the business processes of an erroneous operation of the hardware and software components.

In a fourth aspect, the present invention provides a computer program stored on a computer readable medium, as well as a such a computer readable medium, for use with a computer knowledge system and methods of business information, alerting and analyses as disclosed above.

The computer readable medium can be a floppy disk, a CD-rom, Digital Video Disk (DVD) or other memory or data carrier known to the skilled person. A number of terms used throughout this description are further detailed here below in order to complement the understanding of the person of skill in the art of these terms.

A knowledge system can also be defined as an expert system. An error in the IT/IS components can include changes of whatever nature including disfunctioning or disturbances of the software components.

### BRIEF DESCRIPTION OF THE DRAWINGS

FIG. 1a and 1b schematically show the architecture of an example embodiment of a knowledge system of the present invention, including additional software components.

FIG. 2a shows an embodiment of the infrastructure of an example business process of fixed-telephone connections.

FIG. 2b shows a number of operations being part of a business process.

FIG. 3 shows an embodiment of a user interface showing geographic information about a business process.

FIG. 4 schematically shows dependencies within the functionality of the NERVECENTER knowledge system according to a best mode embodiment of the invention.

### DETAILED DESCRIPTION OF THE INVENTION

For the purpose of teaching of the invention, a preferred embodiment of a knowledge system and methods of the invention are described in the sequel. It will be appreciated by the person skilled in the art that other alternative and equivalent embodiments of the invention can be conceived and reduced to practice without departing form the true spirit of the invention, the scope of the invention being limited only by the appended claims.

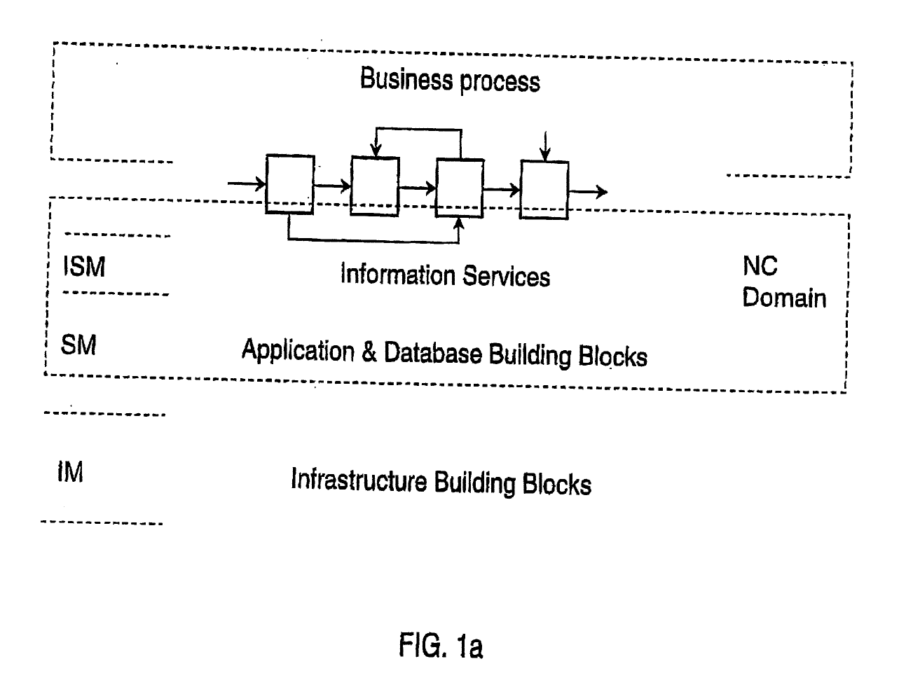

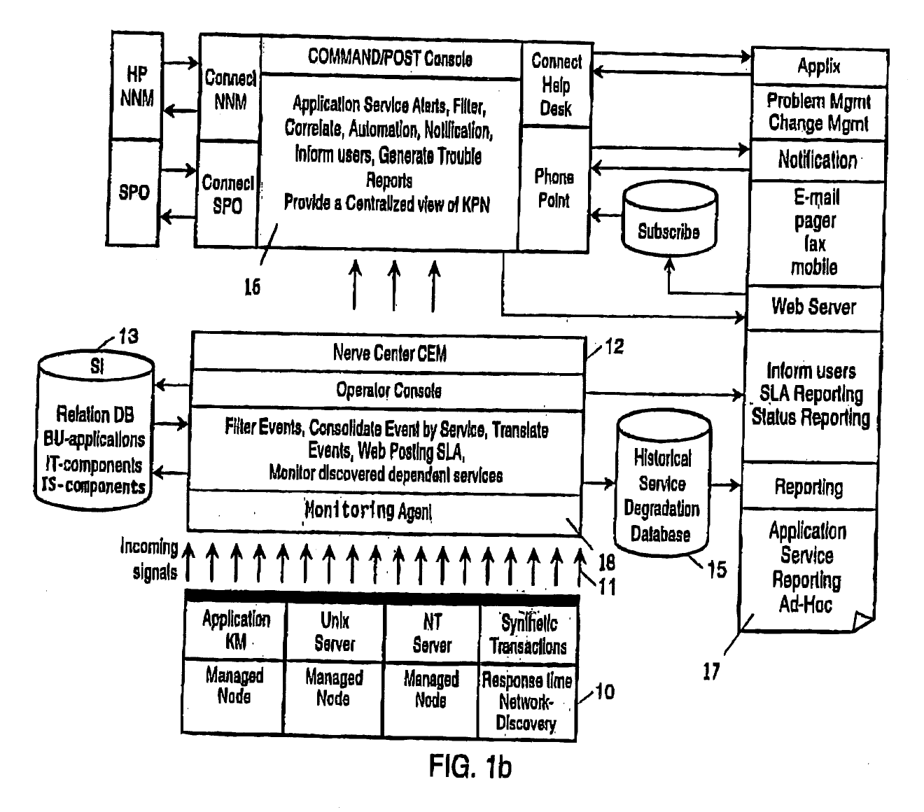

FIG. 1a schematically shows the architecture of an example embodiment of a knowledge system of the present invention.

In the upper part of the figure, several business processes are shown. The business processes or functions, for example, may include financial processes, financial transaction business processes, production installation processes, telecommunication processes, etc.

As can be clearly viewed from the figure, the business processes or functions have several interdependencies, indicated by the arrowlinks between the business processes. An erroneous operation of one or a plurality of the business processes will have an impact on the operation or execution of another or a plurality of other business processes.

The business processes are enabled by Information Technology (IT) components or building blocks, in the present application also indicated by the term software components, and InfraStructure (IS) components or building blocks, in the contekst of the present patent application generally called hardware components. The IS/IT building blocks form part of a computer environment enabling the business processes. In FIG. 1a the IS/IT building blocks are shown in the lower part of the figure. The knowledge system of the present invention is depicted in the middle of FIG. 1a. The knowledge system comprises two main parts, an Information Services (IS) part and an Application & Database Building Blocks part. FIG. 1b schematically shows the architecture of an example embodiment of a knowledge system of the present invention, including additional software components.

The knowledge system of the invention includes the part SI which is a relational database 13 that includes the information about the coupling or the relations between the software and hardware (IS/IT) components and the business processes or functions.

Incoming signals 11 from the IS/IT components 10 are fed to a central agent 12 including a monitoring agent (PATROL) 18. The signals may include the signaling of a change or a disturbance or an error in the software components. The central agent 12 may include functionality on filtering of the incoming signals. The signals from the central agent 12 thereafter are fed to the relational database 13. However, the signals can also be fed directly to the relational database 13.

In the relational database, links are available and made between the software and hardware components 10 and the corresponding business processes or functions. Links are then automatically generated via the central agent 12 to user interfaces 16-17 and a database 15 that stores the occurrence of incoming signals, also called the historical service degradation database 15.

A signal that is generated towards the user interfaces 16-17 and the historical service degradation database 15 is popping up on the user interface. From the user interface several reports can be drawn on the impact of the business processes affected by the signaling due to a change or disturbance or error in the software and hardware components, among others using the contents of the historical database.

Further functionality can be included in the knowledge system by smoothly integrating new software components and interfacing to other knowledge systems or other computer environments.

In the development of the relational database 13, there are a number of steps that can be followed. A first step includes the analysis of the business flow and the analysis of the IS components that support the business process flow. This step includes the identification of functional transactions within the business process, the documentation of possible errors and known failure points, and of known problems within the business transaction flow and the IT/IS components A next step may include the definition of the relationship and dependencies between the individual business steps or transactions within the process, and the dependencies between the individual business steps or transactions within the process and software components of the IT infrastructure supporting the business process on the other hand.

The mapping of the business and IT/IS infrastructure includes the definition of the correlation of the impact of the IT/IS infrastructure events on the business process flow. Furthermore can be provided a definition of threshold alarm levels and alerts and the definition of data presentation formats and reporting formats, which can be made user dependent, on a subscription bases or automatically. The results of these steps are stored as dependencies in the relational database and as links to separate software and hardware components and as separate software components. There can be provided further a software application that monitors the business process flow and an application that monitors the software components. The further functionality of links to a user interface and other functionalities of the knowledge system are to be provided,

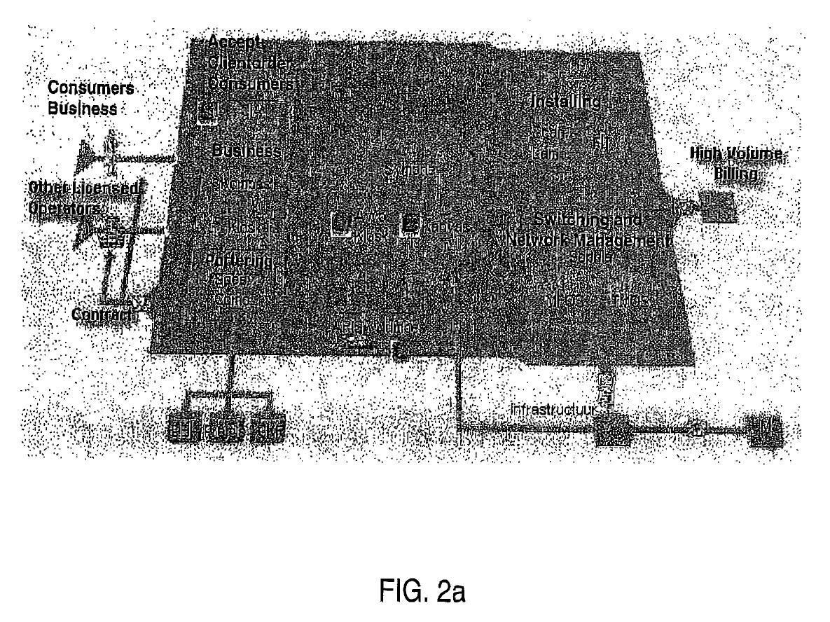

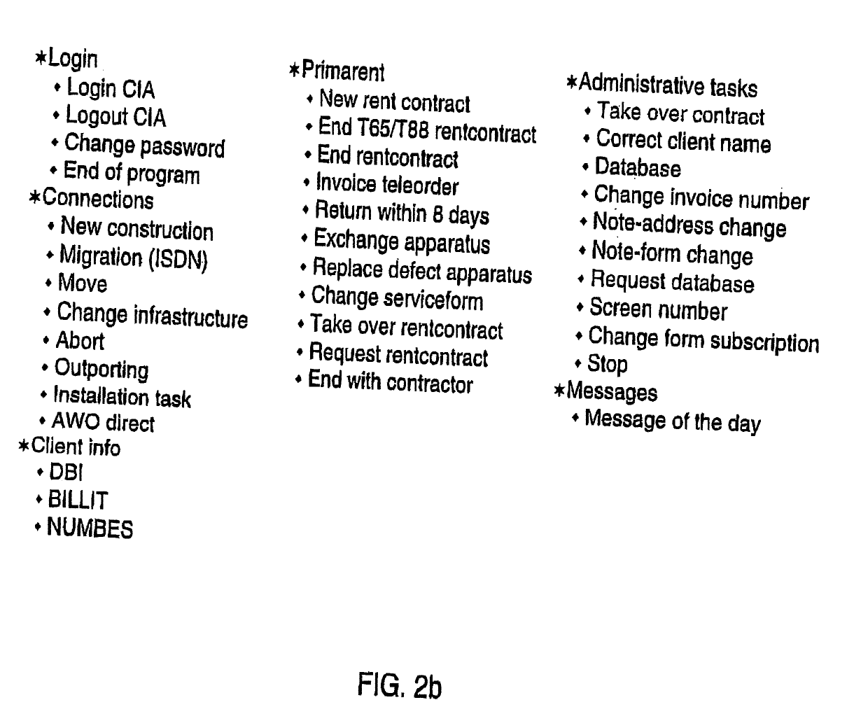

FIG. 2a shows an embodiment of the infrastructure of an example business process of fixed-telephone connections. FIG. 2b indicates a number of operations being part of the business process.

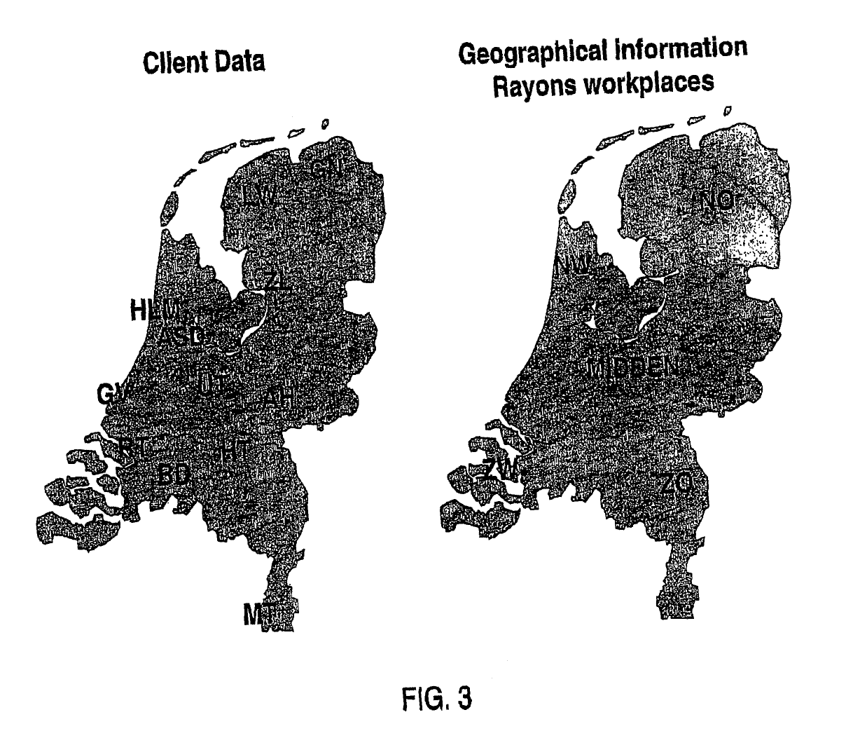

FIG. 3 shows, according to a best mode embodiment of the invention, a user interface showing geographic information about the business process. The business process, as stated above, is one of business processes involved with fixed-telephone connections. One of the parts of this system is the CIA (Client Order Entrance Application) module.

This CIA is interfacing for the entrance of client orders from the consumer market. The CIA is the first part of a chain of software components that link the client order ultimately to the switch connection orders in the telephone central units. The client orders are registered on line. The CIA has interfaces to software components shown in FIG. 2a including modules with client data, infrastucture data, telephone number data, rent data and billing data.

For example the module KANVAS provides to the CIA information about the technical infrastructure such as cables, connections etc. CIA provides to KANVAS the changes that are needed in the technical infrastructure for performing the client order. NUMBES for example contains a database of telephone numbers. If a new number is generated and added to the database, an operator connection is made. The CIA is a 16-bit application and can run under a WINDOWS environment on a PC such as a Fujitsu PC or a DELL PC or any similar PC known to the person of skill in the art. The CIA only contains configuration files; data are stored in the other software components. The different interfaces are based on RPC (T-AAK). The performance of the KANVAS systems is monitored with SYSTAR software. Performance problems of KANVAS lead to a stacking of transactions in the CIA. In order to cope with such problems a knowledge system of the invention such as the NERVECENTER (NC) software shell is to be implemented in order to provide incident control, problem control, change control, configuration management and service level management.

The dependencies in the business process of fixed-telephone connections are analyzed up to the level of the software and hardware components that constitute or monitor the technical process of fixed-telephone connections. These dependencies are stored in a relational database. Scripts are coupled hereto and these scripts generate WebPages.

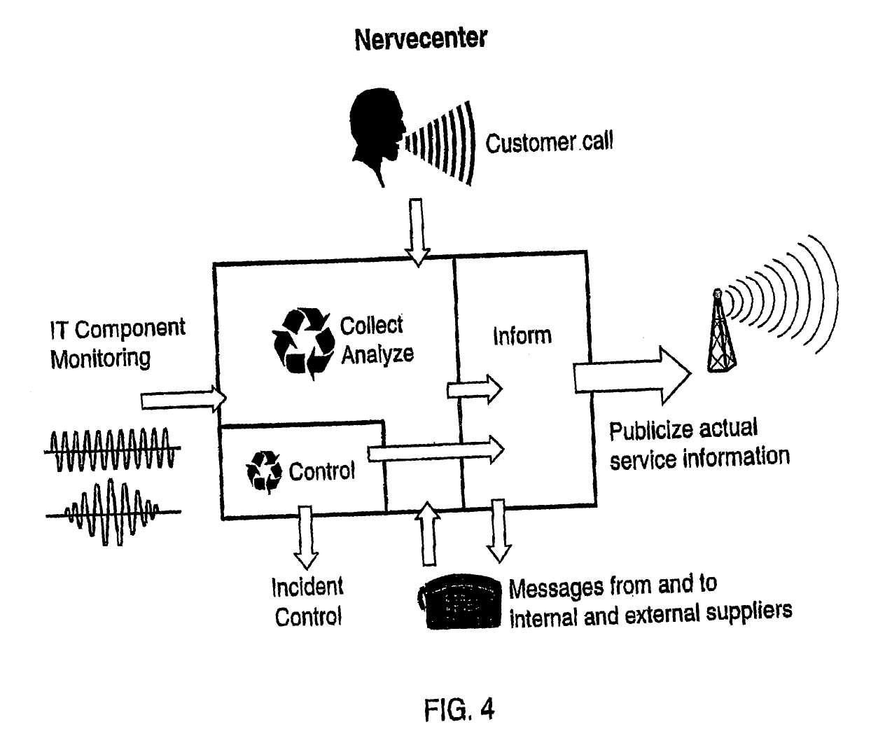

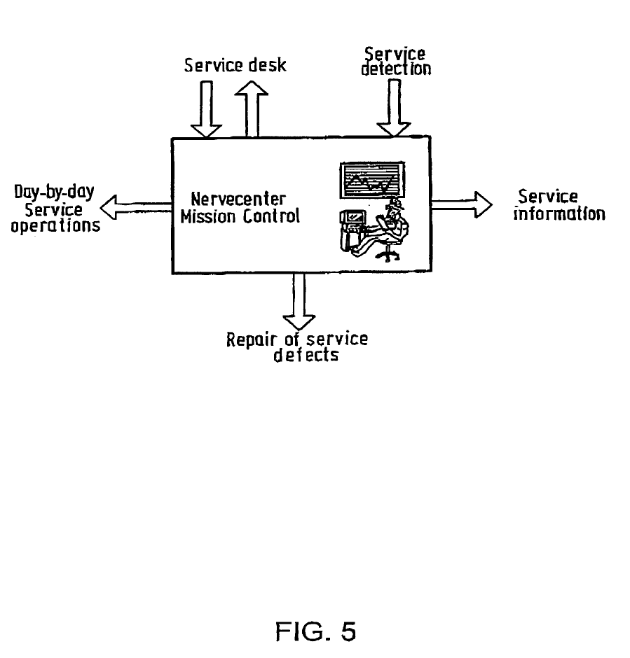

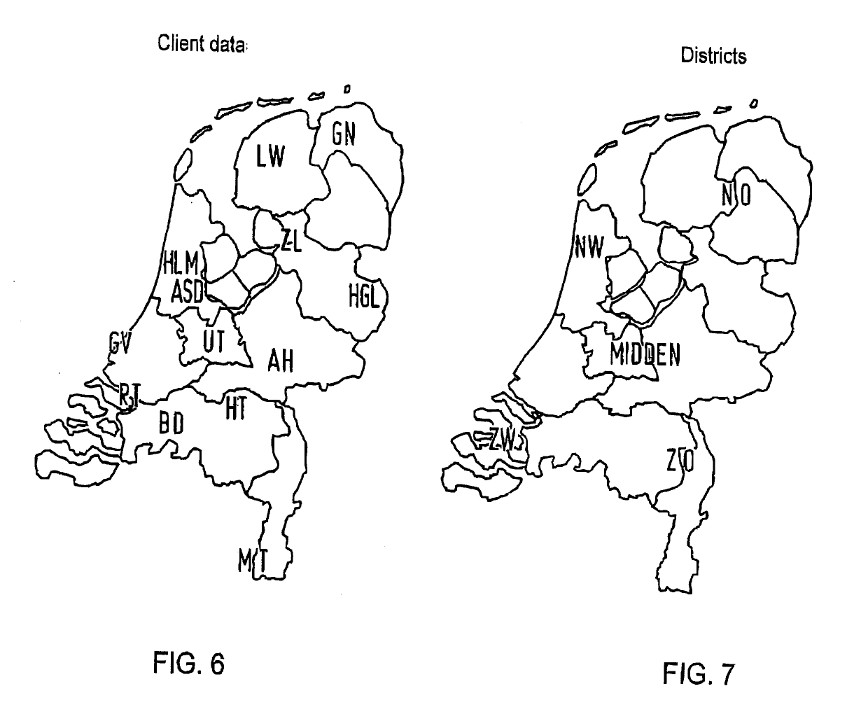

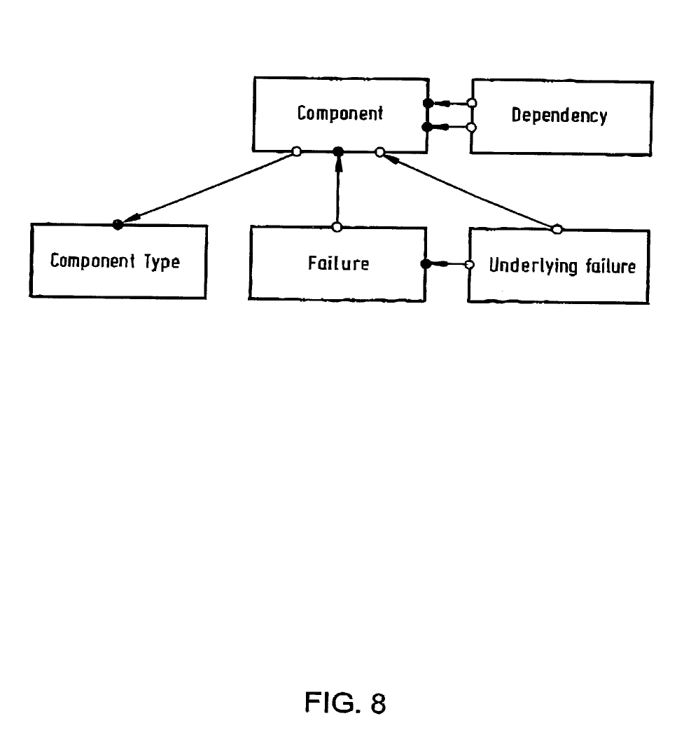

FIG. 4 schematically shows dependencies within the functionality of the NERVECENTER knowledge system according to the best mode embodiment of the invention. A prototype software in an ACCESS database is reduced to practice.

An example of the add-on of the NERVECENTER software to business process of fixed-telephone connections is shown in FIGS. 2b and 3. The geographic extension of the fixed-telephone connections over the Netherlands is shown. The non-availability of parts of the network in different parts of the Netherlands is, in a practical embodiment, indicated by red lights on the map of FIG. 3. The business steps or operations of the list of FIG. 2b that can not be executed, are indicated in red as well. These signals on the user interface are generated through error functions in the software components such as the KANVAS component.

A detailed description of the best made embodiment of the NERVECENTER software is given here below.

1. Deliverables

The Service Informer environment can be subdivided into the following parts:

Miscellanea
Documentation
Presentations
Development
ServiceInformer

the latter directory containing all files relevant for the operational environment.

| Directory/ file name | Description |
|---|---|
| Miscellanea | |
| Documentation | |
| Service Informer - Ontwerp.doc | Functional and technical design |
| Service Informer - Handleiding.doc | User manual |
| Service Informer - APH.doc | Application Production Manual for management |
| Nervecenter.vsd | NerveCenter graphic, used in “Service Informer |
| | - Ontwerp.doc” |
| Service Informer - Gegevensmodel.vsd | Graphic used in “Functional and technical |
| | design” |
| ServiceinformerGegevens.mdb | Database containing data for creating “Service |
| | Informer - Handleiding.doc” |
| Development | |
| Problemen en Wijzigingen.txt | File containing problems with and changes to SI. |
| Serviceinformer (NerveCenter).bat | Command to boot SI in the Nerve Center |
| ServiceInformer.mdb | MS ACCESS program - development version |
| ServiceInformer.mde | MS ACCESS program - user version |
| ScrviceInformer.mic | SI logo; Microsoft Image Composer format |
| ServiceInformer.bmp | Bitmap format |
| ServiceInformer.gif | JPG format |
| ServiceInformer.jpg | MS EXCEL spreadsheet for creating cross |
| | reference tables |
| ServiceInformer.xls | |
| ServicelnformerGegeveris.mdb | MS ACCESS database; data as used during |
| | development |
| Presentations | |
| Presentatie Stuurgroep 1999-09-10.ppt | |
| Presentatie Agora-CIA.ppt | |
| ServiceInformer | |
| Default.Htm | Initial page for opening the Intranet |
| Info.Htm | Information page |
| Kop.Htm | Header at top of page according to Agora |
| | standard |
| Menu.Htm | Menu below header according to Agora standard |
| Graphics | |
| Demonstratie.htm | Test page for displaying small regional maps |
| Pixel.gif | 1 pixel graphic (invisible) |
| ServiceInformer.jpg | SI logo; JPEG format |
| Goed.gif Storing.gif | Button - OK situation (green) |
| Stop-gif | Button - Failure situatian (red) |
| Tab25.gif | Invisible graphic of 25 pixel length for tabulation |
| Client data | |
| Achtergrond.gif | Small map for the correct (green) situation |
| AmsterdamStop.gif | Amsterdam with a stop situation |
| AmsterdamStoring.gif | Amsterdam with a failure situation |
| AmhemStop.gif | |
| AmhemStoring.gif | |
| BredaStoring.gif | |
| BredaStop.gif | |
| Den BoschStop.gif | |
| Den BoschStoring.gif | |
| Den HaagStop.gif | |
| Den HaagStoring.gif | |
| GroningenStop.gif | |
| GroningenStoring.gif | |
| HaarlemStop.gif | |
| HaarlemStoring.gif | |
| HengeloStop.gif | |
| HengeloStoring.gif | |
| LeeuwardenStop.gif | |
| LeeuwardenStoring.gif | |
| MaastrichtStop.gif | |
| MaastrichtStoring.gif | |
| RotterdamStop.gif | |
| RotterdamStoring.gif | |
| UtrechtStop.gif | |
| UtrechtStoring.gif | |
| Zwollestop.gif | |
| ZwolleStoring.gif | |
| Districts | |
| Achtergrond.gif | Graphic showing the correct (green) situation |
| Rayon Indelingtxt | Arrangement of districts across the districts |
| Rayon MiddenStop.gif | Central district showing a stop situation |
| Rayon MiddenStoring.gif | Central district showing a failure situation |
| Rayon NoordoostStop.gif | |
| Rayon NoordoostStoring.gif | |
| Rayon NoordwestStop.gif | |
| Rayon NoordwestStoring.gif | |
| Rayon ZuidoostStop.gif | |
| Rayon ZuidoostStoring.gif | |
| Rayon ZuidwestStop.gif | |
| Rayon ZuidwestStoring.gif | |
| Fixed telephony | |
| Achtergrond.gif | Background showing the correct (green) situation |
| AW0Stop.gif | AWO showing a stop situation |
| AW0Storing.gif | AWO showing a faijure situation |
| CIAStop.gif | |
| CIAStoring.gif | |
| KanvasStonng.gif | |
| KanvasStop.gif | |
| NumbesStop.gif | |
| NumbesStoring.gif | |
| PosterOrigineel.jpg | |
| Ruimte.gif | Invisible graphic, 1 pixel wide and of equal height |
| | as Achtergrond.gif |
| Application | |
| ServiceInformer.bmp | SI logo; BMP format |
| ServiceInformerGegevens.indb | Service Informer - Operational data |
| ServiceInformer.mde | Service Informer - Pmgram |
| Css | |
| Agora.Css | Cascading Style Sheet according to Agora |
| | standard |
| Graphics | |
| Pic_Mail.Gif | E-mail graphic according to Agora standard |
| Pic_Top.Gif | Go-to-top graphic according to Agora standard |
| Topagora.Gif | Home graphic according to Agora standard |
| Toplogo.Gif | Agora logo |
| Topnavi.Gif | Navigation graphic according to Agora standard |
| Java | |
| menu.js | Java script for menu control according to Agora |
| | standard |
| Templates | |
| StatusKop.htm | Standard header lines for generated status pages |
| StatusVoet.htm | Standard footer lines for generated status pages |
| Status | |
| Status.htm . . . Status999.htm | Status pages generated by SI |

Contents

1. INTRODUCTION 7

1.1. OBJECTIVE OF THIS DOCUMENT 7

1.2. DISTRIBUTION LIST 7

2. THE NERVECENTER INTRANET ENVIRONMENT 8

2.1. THE GENERAL STRUCTURE 8

2.2. SERVICE INFORMATION VIA THE INTRANET 9

2.2.1. Introduction 9

2.2.2. The manual method 9

2.2.3. Complete integration 9

2.2.4. The Nervecenter Intranet 10

3. FUNCTIONAL DESIGN 1

3.1. INTRODUCTION 11

3.2. CURRENT SERVICE STATUS 12

3.3. REPORTING FAILURES 13

3.4. REQUESTING THE CURRENT STATUS 13

3.4.1. Status page 13

3.4.2. Status of applications 14

3.4.3. Status Client-order Input Application 14

3.5. DETAILED FAILURE INFORMATION 14

3.6. EFFECT ON CLIENT DATA AND WORK LOCATIONS 15

4. TECHNICAL DESIGN 16

4.1. STATUS TRANSFER BETWEEN COMPONENTS 16

4.1.1. Basic algorithm 16

4.1.2. Extended algorithm 17

4.1.3. Addition of client and district dependencies 17

4.2. CREATING A STATUS OVERVIEW 18

4.2.1. Highest level; Status.htm 18

4.2.2. Component type level 18

4.3. INTRANET DIRECTORY STRUCTURE 18

4.4. GRAPHICS 19

4.4.1. Client and work regions 19

4.4.2. Graphically represented component types 19

4.5. DATA MODEL 20

4.5.1. Settings 20

4.5.2. ComponentType 22

4.5.3. Component 23

4.5.4. Dependency 23

4.5.5. Failure 25

4.5.6. Underlying failure 25

4.6. ACCESS CONTROL AND USER PROFILES 27

1. Introduction

The KPN Nervecenter helps in making the step from infrastructure to service management. One of the parts of this is timely informing the client in regard to failures and the time required to resolve them. This informing of the client is supported by an Intranet on which the current status of the various services is displayed in understandable language for the client.

1.1. Objective of This Document

This document describes the constraints the functional and technical design of the Intranet site which forms part of the Nervecenter project.

1.2. Distribution List

“Click here and type distribution list”

2. The Nervecenter Intranet Environment

2.1. The General Structure

The Nervecenter is represented by the conceptual drawing below:

See FIG. 5

The Nervecenter is a central place where all communication takes place:

The Service desk maintains contact with the clients by registering incidents and their progress.

Service detection monitors all services, and registers correct functioning and possible deviations from standard settings.

Repair of service defects responds to incoming ‘complaints’ and performs repair operations, while

Day-by-day Service Operations performs daily operations such as creating new users and carrying out routine tasks.

Finally, Service Information reports the status and progress of all these activities to users, clients and management. Examples; Current Status, Outstanding Problems and Implemented/Planned changes.

2.2. Service Information Via the Intranet

2.2.1. Introduction

The Intranet, on which this document is focussed, is the implementation of the Service Information part of the Nervecenter. Before the details of this Intranet are discussed, two other implementation possibilities are considered first: The manual method and Complete integration. By discussing both possibilities beforehand, a foundation is laid down for the ultimate implementation selection: the currently feasible happy mean.

2.2.2. The Manual Method

The (technically) easiest method for implementing the Nervecenter is to set up a location with a number of telephones. The staff at this location ‘calls around’ to collect information and is called by the outside world.

Of course it is obvious that this is impractical. The significance of this suggestion is that such a central service monitoring point, rather than highly sophisticated technical solutions, should be the objective of the Nervecenter.

Although charming in its technical simplicity, this option must be disregarded since an on-line information facility is not feasible.

2.2.3. Complete Integration

Of course it is also possible to equip the Nervecenter with a maximum of tools:

The Service desk is set up around a Service Management package containing all Services and underlying IT components.

Service detection automatically registers all events that occur in the Service Management environment (trouble tickets).

Repair of service defects is driven by the incidents and Problems entered, while

Day by-day Service Operations performs the operations on the basis of the agreed Changes in the Service Management package.

For Service Information it is then ultimately easy to take care of the information facility: all information is centrally present in the database of the Service Management package.

Such a complete integration certainly has its merits; all information regarding all IT components is centrally available; both the statistical information (name, type, number) and the status (correct, failure, stop) and the relationship with all services are then stored, so that the provision of information is optimal. All possible questions can be answered by querying the central database! This option is interesting because of its completeness, but must be disregarded because of its technical complexity.

2.2.4. The Nervecenter Intranet

After the two previous possibilities, representing the extremes of a technically very simple solution and a technically very complex solution, a third option is now considered: a middle course which makes use of modem resources but which can be overseen in regard to technical complexity and can be implemented within a reasonable time span.

The Service Information part of the Nervecenter is implemented by a small application called Service Informer, functioning alongside the other Nervecenter components. This independent component is responsible for the information provision of the Nervecenter to the client. The information can be retrieved from a web browser by the client, and forms part of the Agora Intranet of KPN Telecom.

Service Informer is manually fed from the incidents database. The incidents database is filled on the basis of messages from the helpdesk, the experience of various management groups, and events discovered by Patrol.

3. Functional Design

3.1. Introduction

The Nervecenter Intranet provides services users of KPN Datacenter services insight into the functioning of those services. The following information is available:

The current service status: a summary of the currently outstanding incidents.

In the future, the following data will also be made available through the Intranet:

Information regarding service changes. This applies to future changes, but also to recently implemented changes. Recent changes can indicate current errors, while future changes can provide a warning for future failures.

Information regarding known errors. Users can consult this list first to see whether a solution for the error that has occurred is already available.

A very important requirement for the Nervecenter Intranet is that all information is presented from the viewpoint of the user.

3.2. Current Service Status

The Nervecenter provides a pilot for CIA (Client-order Input Application). This application has the following menu structure:

| | |
|---|---|
| Login | Return within 8 days |
| Login CIA | Exchange apparatus |
| Login CIA | Replace defect apparatus |
| Change password | Change seiviceform |
| End of program | Take over rentcontract |
| | Request rentcontract |
| Connections | |
| New construction | |
| Migration (ISDN) | Administrative tasks |
| Move | Take over contract |
| Change infrastructure | Correct client name |
| Abort | Database |
| Outporting | Change invoice number |
| Installation task | Note-address change |
| AWO direct | Note-form change |
| | Request database |
| Client info | Screen number |
| DBI | Change form subscription |
| BILLIT | Stop |
| NUMBES | |
| Client info | |
| Primarent | DBI |
| New rent contract | BILLIT |
| End T65-T88 rent contract | NUMBES |
| End rentcontract | |
| Invoice teleorder | Messages |
| | Message of the day |

Information display to users is always based on the above structure.

The IT Infrastructure managers, however, look at this in another way! Depending upon their position and/or competence, they think in terms of Tuxedo transactions, Application Servers or Windows NT Systems. The job of the Service Informer is to translate from technology to user functions.

In general, it can be said that an application has user functions which, in turn, are dependent upon IT components. All these matters, however, can be represented by a generic “component”. Each component may be dependent upon one or more components. Each component may also influence other components.

When a user requests data, he is interested only in the status of an application (including the thereto related functions). The status of underlying components is irrelevant. For this reason, each component also has a type (ComponentType), the type of the component determining whether or not it is relevant for the client.

3.3. Reporting Failures

Failures in the IT infrastructure can be reported on each component. A failure has an effect on the service (EffectOpService): Geen (None); Storing (Failure) or Stop. Each component influences the status of all other components which are dependent upon it. This continues to the ‘highest’ level, until the component found has no higher component.

3.4. Requesting the Current Status

The status of applications and application functions can be requested through the Intranet site.

3.4.1. Status Page

The first page shown displays the status information at the highest level:

| | |
|---|---|
| kpn telecom | |
| KPN Nervecenter | Service Information |

Services
Fixed Telephony

A choice can be made between detailed information regarding Services or an overall fixed telephony overview.

3.4.2. Status of Applications

If Services is clicked, the following page is displayed:

| | |
|---|---|
| kpn telecom | |
| KPN Nervecenter | Services |

Client-order input Application

3.4.3. Status Client-Order Input Application

If Client-order Input Application is clicked, the following page is displayed:

kpn telecom

| | |
|---|---|
| KPN Nervecenter - Service information | Client-order Input Application |

| | | |
|---|---|---|
| Connections | Primarent | Administrative tasks |
| 1. New construction | 1. New rent contract | 1. Take over contract |
| 2. Migration (ISDN) | 2. End T65-T88 rent contract | 2. Correct client name |
| 3. Move | 3. End rentcontract | 3. Database |
| 4. Change infrastructure | 4. Invoice teleorder | 4. Change invoice number |
| 5. Abort | 5. Return within 8 days | 5. Note-address change |
| 6. Outporting | 6. Exchange apparatus | 6. Note-form change |
| 7. Installation task | 7. Replace defect apparatus | 7. Request database |
| 8. AWO direct | 8. Change seivice for | 8. Screen number |
| Client Info | 9. Take over rentcontract | 9. Change form subscription |
| 1. DBI | 10. Request rentcontract | 10. Stop |
| 2. BILLIT | 11. End with contractor | Messages |
| 3. NUMBES | | Message of the day |

In the event of application functions for which a failure has occurred (yellow or red), a page displaying a failure overview can be accessed by means of a reference.

3.5. Detailed Failure Information

In the event of a failure, the following is displayed on the Intranet:

Failures for thi5 or underlying components

Database Brada is down

| | |
|---|---|
| Time: | The failure started on 1999/09/28 at 11:00:00. |
| | The problem is expected to be resolved on 1999/09/28 |
| | at 15:00:00 |
| Referencec: | The reference number of the failure is TARGET 776 |
| Companent: | AWO Database Breda |
| Effect: | Client data: Breda |
| | Districts: All |

3.6. Effect on Client Data and Work Locations

As can be seen in the detailed data of the above failure, a failure may be general, or limited to one or more databases with client data. This information is graphically displayed on the intranet pages as shown in the accompanying figure:

The failure reported only impacts the client data in Breda.

See FIG. 6

The same applies for the work site: the place where the application is used.

Since in the example the failure does not impact a specific work site, they all remain GREEN. Attention: of course all work sites will still have problems with the data of clients in Breda.

See FIG. 7

4. Technical Design

4.1. Status Transfer Between Components

When a component failure is reported, it impacts all ‘higher’ components, that is to say, the components which are dependent upon that component. This chapter describes the process of how the status of ‘higher’ components is determined.

First a simple algorithm is described, after which the final algorithm is determined.

It would be possible to establish the status of the components using a recursive algorithm, and then to create the HTML pages directly. This option is not chosen, however, since the status of the components is then not directly visible for the maintenance program (only from the web site) and such an approach results in a heavier-load on the database system (all required information must be generated over and over).

4.1.1. Basic Algorithm

Failures are reported on components. These components impact other components in a rising line, until the highest hierarchy level is reached. The algorithm for this transfer functions is as follows:

1. As a first step, the status (ComponentStatus) of all components is set to ‘Goed’ (Correct), as though no failure whatsoever is present.

2. Next, all failures are read (Afgesloten=FALSE and EffectOpService>Geen, i.e. Closed=FALSE and EffecfOnService>None). For each failure, the status of the related component is made equal to that of the failure, provided ComponentStatus<EffectOpService (i.e. ComponentStatus<EffectOnService). This latter condition is required, since several failures are possible for a component.

During this process, all component numbers (ComponentNr) of changed components are simultaneously saved; this list is called ComponentNummers (i.e. ComponentNumbers).

3. Subsequently, all dependencies (Afhankelijkheden) are read for which CornponentNr2 (i.e. ComponentNumber2) occurs in the list ComponentNummers. These components have been changed and can thus change upstream components. The status of ComponentNrl is now made equal to that of ComponentNr2 (provided the ComponentStatus is increased). During this process, all component numbers (ComponentNr) of changed components are simultaneously saved; this list is called ComponentNummers (i.e. ComponentNumbers).

4. The previous step is repeated until no further dependencies (Afhankelijkheden) are found.

As a result, the (transferred) status of all components is directly known, without having to consult underlying components. The underlying component which caused the problems, however, cannot be retrieved directly without retrieving this information “downstream”. To this end the table StatusOorzaak (i.e. StatusReason) is used, the process described above being extended as follows.

4.1.2. Extended Algorithm

Failures are reported on components. These components impact other components to an increasing extent, until the highest hierarchy level is reached. The algorithm for this transfer functions is as follows:

1. As a first step, the status (ComponentStatus) of all components is set to ‘Goed’ (Correct), as though no failure whatsoever is present.

2. Next, all failures are read (Afgesloten=FALSE and EffectOpService>Geen, i.e. Closed=FALSE and EffectOnService>None). For each failure, the status of the related component is made equal to that of the failure, provided ComponentStatus<EffectOpService. This latter condition is required, since several failures are possible for a component.

The failure data are also copied to OnderliggendeStoring (i.e. UnderlyingFailure), so that the failure causing the ComponentStatus is directly visible at the component level. During this process, all component numbers (ComponentNr) of changed components are simultaneously saved: this list is called ComponentNummers (i.e. ComponentNumbers).

3. Subsequently, all dependencies (Afhankelijkheden) are read for which ComponentNr2 occurs in the list ComponentNummers. These components have been changed and can thus change upstream components. The status of ComponentNrl is now made equal to that of ComponentNr2 (provided the ComponentStatus is increased).

The data are of the OnderliggendeStoring (of Component 2) are also copied to StatusOorzaak, so that the failure causing the ComponentStatus is again directly visible at the component level.

During this process, all component numbers (ComponentNr) of changed components are simultaneously saved; this list is called ComponentNummers (i.e. ComponentNumbers).

4. The previous step is repeated until no further dependencies (Afhankelijkheden) are found.

4.1.3. Addition of Client and District Dependencies

In Service Informer, two special component types can be entered which represent KlantRegio (i.e. ClientRegion) and the WerkRegio (i.e. WorkRegion). Both component types can comprise a maximum of 24 components and these components must be numbered from 1 . . . 24.

The reason for this is that the component numbers can be stored together in one binary 24 bit register, which will be used when transferring the dependencies of KlantRegio and WerkRegio. Each component has a register KlantMask (i.e. ClientMask) and WorkMask (i.e. WorkMask). These masks initially contain OxFFFFFF, meaning; all regions.

It is subsequently determined per component whether the component has been made DIRECTLY dependent upon KlantRegio or WerkRegio (by adding a dependency of a component of such a type). For each applicable component, the KlantMask and the RegioMask are made equal to the sum of the second power of the KlantRegio or Werkregio number.

This number is subsequently taken along in the previously described ‘Status transfer process’ with the OnderliggendeStoring (i.e. UnderlyingFailure) assigned to a component when a component is dependent upon a specific KlantRegio or WerkRegio, the failure for that component of course impacts only that KlantRegio or WerkRegio.

If a failure is transferred to a component which itself is again specific for a certain KlantRegio or WerkRegio, the information for the OnderliggendeStoring is adapted using an AND function: the failure is then only related to that KlantRegio or WerkRegio on which both the underlying component AND the thereto related component have impact.

When an underlying failure (OnderliggendeStoring) is created for a component, and this failure was already created via another route, the KlantRegio and WerkRegio information of the underlying failures are added together (OR function).

In this way it can be established for each failure at the component level whether the failure is general (all client or work regions) or whether the failure is restricted. This can then be visualised, as shown above, with the KlantRegio and WerkRegio maps.

4.2. Creating a Status Overview

4.2.1. Highest Level; Status.htm

First a status page (Status.htm) is generated which, at the highest level, indicates the status of the infrastructure. This page comprises all component types for which the option GenereerStatusPagina=TRUE (i.e. GenerateStatusPage=TRUE). Detailed information for each component type can be retrieved by means of a hyperlink.

4.2.2. Component Type Level

For each ComponentType (with the option GenereerStatusPagina=TRUE), a status page is generated which shows the status of the underlying structure. For example, the following pages could be created:

ApplicatieStatus (i.e. ApplicationStatus)

TransactieStatus (i.e. TransactionStatus)

LocatieStatus (i.e. LocationStatus)

These pages contain one line for each component at the highest level, which subsequently refers to an underlying page in which the whole structure of dependent components of the same type is included. The name of this underlying page is generated by means of the main page and the component number (ComponentNr).

End users will usually focus on the application status page (ApplicatieStatus). As soon as this page indicates that there are problems in an application, they can click the related application reference to find the underlying application parts where the problem has occurred.

4.3. Intranet Directory Structure

| <root> | | |
|---|---|---|
| | JAfbeeldingen (i.e. ./Graphics) | All graphic images |
| | JJava | All Java scripts, |
| | JStatus | All generated pages. |
| | JSjablonen (i.e. Templates) | Templates for generating status pages. |
| | JApplicatie (i.e. Application) | Directory with MS ACCESSS management program. |
| 4.4. | Graphics | |
| 4.4.1. | Client and work regions | |

Client regions (Klantregio) and work regions (Werkregio) are graphically represented, but Service Informer itself knows nothing of these components. The manner in which these components are depicted is as follows.

1. In the settings, a component type is assigned to a client region (KlantRegio) and a work region (WerkRegio). In the CIA situation, these are the component types Klantgegevens (i.e. Client data) and Rayon (i.e. District) respectively. In the graphics directory (Afbeeldingen), two subdirectories must therefore be creating with the same names.

2. In order to be able to depict the correct situation (Goed), these two directories must contain the background graphic Achtergrond.gif. This graphic shows The Netherlands with 13 green districts. This graphic must be no greater than 200×200 pixels.

3. The components of type Klantgegevens (i.e. Client data) have the names ‘Amhem’ . . . ‘Zwolle’. These districts can have the status of Storing (i.e. Failure) and Stop, and should therefore comprise two graphics for each component AmhemStop.gif and AmhemStofing.gif., ZwolleStoring.gif.

4. The related pages first display the background graphic Achterground.gif and then, superimposed, the failing components. These graphics have exactly the same size as the background, but contain only the component in yellow or red.

4.4.2. Graphically Represented Component Types

Graphically represented component types function in a similar manner as described above:

1. In directory Afbeeldingen (i.e. Graphics) a subdirectory must be created which has the same name as the component type.

2. This directory must contain two graphics: Achtergrond.gif (Background.git) and Ruimte.gif (Space.gif). Ruimte.gif is 1 pixel wide and has the same height as Achtergrond.gif.

3. For each component within this type, two graphics <ComponentNaam>Storing.gif (i.e. <ComponentName>Failure.gif) and <ComponentNaam>Stop.gif (i.e. <ComponentName>Stop.gif) must exist.

4.5. Data Model

| Table | Description | |
|---|---|---|
| Instellingen (i.e. Settings) | Various parameters for the application function. | |
| ComponentType | A component type, for example Applicatie (i.e. Application), | |
| | Transactie (i.e. Transaction) or IT component | |
| Component | An application function or IT component. | |
| Afhankelijkheid (i.e. Dependencies) | The dependencies between two components. | |
| Storing (i.e. Failure) | An event which is registered for one component. | |
| OnderliggendeStoring | An event for a component which is related to an underlying component | |
| (i.e. UnderlyingFailure) | component | |
| 4.5.1. Settings | | |
| Column | Type | Length Unit/Remarks |
| InstellingenNr (SettingsNumber) | Numeric | Unique code for internal use. |
| IntranetPad (IntranetPath) | Alphanumeric 255 | Path in which Intranet web pages are |
| | | stored. |
| IntranetURL | Alphanumeric 255 | URL where the Intranet pages can |
| | | be found. |
| KlantComponentTypeNr | Numeric | The component type number of the |
| (ClientComponentTypeNumber) | | components which display the client |
| | | region (KlantRegio). |
| WerkComponentTypeNr | Numeric | The component type number of the |
| (WorkComponentTypeNumber) | | components which display the work |
| | | region (WerkRegio). |
| RegioInfo (RegionInfo) | Numeric | Manner in which client/work regions |
| | | are displayed. |
| | | 0 = None |
| | | 1 = Matrix |
| | | 2 = Map |

| | |
|---|---|
| Fixed settings: | |
| Graphics | Are expected in <IntranetLTRL>/Afbeeldingen. |
| Status correct icon | For this, <IntranetURL>/Afbeeldingen/Goed.gif is used. |
| Status failure icon | For this, <IntranetURL>/Afbeeldingen/Storing.gif is used. |
| Status stop icon | For this, <IntranetURL>/Afbeeldingen/Stop.gif is used. |
| Status pages | Are stored in <IntranctPad>/Status and expected in <IntranetURL>/Status. The first page |
| | is called Status.htm. |

| | | |
|---|---|---|
| Column | Type | Length Unit/Remarks |
| 4.5.2. ComponentType | | |
| ComponentTypeNr | Numeric | |
| (ComponenfTypeNumbor) | | |
| ComponentTypeNaam | Alphanumeric 100 | For example: |
| (ComponentTypeName) | | 1 = Application |
| | | 2 = Transaction |
| | | 3 = IT component |
| GenereerStatusPagina | Boolean | TRUE: an information page for this |
| (GenerateStatusPage) | | level is generated. |
| StatusPaginaNaam | Alphanumeiic 100 | The name of the status page to be |
| (StatusPageName) | | generated. |
| ComponentStatus | | Status of the component, derived |
| | | from failures in underlying |
| | | components. |
| Volgorde (Sequence) | Numeric | The order in which component types |
| | | are displayed on the screen. |
| Grafisch (Graphical) | Boolean | The Intranet page must contain a |
| | | graphical representation of the |
| | | components (rather than a textual |
| | | representation) |
| 4.5.3. Component | | |
| ComponentNr | Numeric | Unique code for internal use. |
| (ComponentNumber) | | |
| ComponentNaam | Alphanumeric 100 | → ComponentType |
| (ComponentName) | | Status of the component, derived |
| | | from failures for this and underlying |
| | | components.. |
| MenuStructuur (MenuStructure) | Alphanumeric 20 | Numbering of components for |
| | | applying structure to the display. |
| NieuwKolom (NewColumn) | Boolean | Indicator for starting a new column |
| | | on status page. |
| GeenStoringen (NoFailures) | Boolean | No failures may be created for this |
| | | component; the component is used |
| | | only to group components. |
| Niveau (Levet) | Numeric | Depth of the numbering used. |
| MenuNiveau1 (MenuLevel1) | Numeric | With the aid of these inputs the user |
| | | indicates the hierarchy in the |
| | | overview. |
| MenuNiveau2 (MenuLevel2) | Numeric | |
| MenuNiveau3 (MenuLovel3) | Numeric | |
| KlantMask (ClientMask) | Numeric | The sum of 2 **MenuNiveau 1 of all |
| | | components of type KlantRegio |
| | | (ClientRegion) which are assigned to |
| | | this component. |
| | | 0xFFFFFF = all regions |
| WerkMask (WorkMask) | Numeric | As for WerkRegio (WorkRegion). |
| 4.5.4. Dependency | | |
| ComponentNr1 | Numeric | → Component |
| (ComponentNumber1) | | |
| ComponentNr2 Numeric | | → Component. |
| (ComponentNumber2) | | |

Component 1 is dependent upon Component 2.

| | | |
|---|---|---|
| 4.5.5. Failure | | |
| StoringNr (FailureNumber) | Numeric | Unique code for internal use. |
| ComponentNr (ComponentNumber) | Numeric | → Component |
| Afgesloten (Closed) | Boolean | TRUE: The failure is closed and |
| | | exits only or future reference. |
| EffectOpService (EffectOnService) | Numeric | 1 = None |
| | | 2 =Failure |
| | | 3 Stop |
| Omschrijving (Description) | Memo | |
| InterneOpmerkingen | Memo | |
| (InternalRemarks) | | |
| Begin (Start) | DatumTijd | |
| | (DateTime) | |
| Eind (End) | DatumTijd | |
| | (DateTime) | |
| ExtemeReferentie | Alphanumeric 100 | Reference, for example to |
| (ExternalReference) | | service (ExternalReference) |
| | | management package. |
| | | Target = Incident # |
| 4.5.6. Underlying failure | | |
| ComponentNr | Numeric | → Component. |
| (ComponentNumber) | | |
| StoringNr (FailureNumber) | Numeric | → Storing (Failure) The failure which |
| | | was transferred to this component |
| KlantMask (ClientMask) | Numeric | The client regions (KlantRegio) to |
| | | which the underlying failure |
| | | (OnderliggendeStoring) applies. |
| | | 0xFFFFFF = all regions |
| WerkMask (WorkMask) | Numeric | As for work regions (WerkRegio). |

4.6. Access Control and User Profiles

In the first version of the program, access control and/or user profiles is not provided. Access control can be implemented by placing in the software in a protected directory in the network.

1. A computer knowledge system, for operation in a computer environment using a plurality of hardware and software components operatively arranged for enabling a plurality of business processes, said computer knowledge system comprises:
a monitoring agent, arranged for collecting data providing information about the operation of said hardware and software components;
a relational database, storing data providing information about the operation of said business processes and error data relating to erroneous operation of said hardware and software components; and
a user interface, arranged for providing information about the operation of said business processes using said data collected by said monitoring agent and said data stored in said relational database,
said relational database being arranged for providing information towards said user interface about the impact on the operation of said business processes of an errroneous operation of said hardware and software components.

2. A computer knowledge system according to claim 1, wherein said relational database comprises data identifying functional transactions within said business processes and dependencies between functional transactions of said business processes, wherein said user interface is arranged for correlating said error data and said functional transactions data for providing said information about the impact on said business processes of an erroneous operation of said hardware and software components.

3. A computer knowledge system according to claim 2, wherein said user interface is arranged for providing said information about said business processes indicating at least one of a group comprising:
the extent to which business processes are influenced by a disturbance in said software and hardware components;
the extent to which business processes are influenced by a functional error in said hardware and software components;
the extent to which business processes are influenced by a functional error in said hardware and software components, which functional error cannot directly be monitored;
the extent to which business processes are influenced by an externally applied change, such as a predetermined change for performing impact analyses, in said hardware and software components; and
the extent to which business processes are available in the case of an erroneous operation of said hardware and software components.

4. A computer knowledge system according to any of the previous claims, further comprising a historical database, storing historical data about erroneous operation of said hardware and software components and the impact thereof on said business processes, wherein said user interface is arranged for providing said information about the impact on said business processes of an erroneous operation of said hardware and software components using said historical data.

5. A computer knowledge system according to any of the previous claims, wherein said user interface is arranged for providing said information about the impact on the operation of said business processes of an erroneous operation of said hardware and software components in a predetermined format adapted to the user of said information.

6. A computer knowledge system according to any of the previous claims, wherein said user interface is arranged for providing said information about the impact on said business processes of an erroneous operation of said hardware and software components in terms of its impact on at least one of a group comprising:
functionality of the business processes;
usability of the business processes;
maintainability of the business processes;
efficiency of the business processes;
reliability of the business processes; and
changeability of the business processes.

7. A computer knowledge system according to any of the previous claims, wherein said monitoring agent, said relational database and said user interface connect through a central agent.

8. A computer knowledge system according to any of the previous claims, wherein said monitoring agent is arranged for collecting information about the operation of said hardware and software components using at least one of a group comprising:
workflow data provided by said computer environment;
system monitoring data; and
data accumulated in a data warehouse of said computer environment.

9. A computer knowledge system according to claim 8, wherein said monitoring agent comprises a knowledge module, operating with a business flow monitor and a component monitor for collecting data providing information about the operation of said business processes and said hardware and software components.

10. A computer knowledge system according to claim 9, wherein said knowledge module is arranged for collecting data with respect to at least one of a group comprising:
availability of critical components;
communications performance between critical components;
critical messages in application and system log files;
synthetic transaction from end user view;
application and system processes;
database and critical table(s) data availability; and
system resource availability and performance.

11. A computer knowledge system according to any of the previous claims, wherein said user interface is arranged for providing said information on an automated basis comprising at least one of a group including:
a notification message;
a standard report;
an HTML page; and
a trouble ticket.

12. A computer knowledge system according to claim 11, wherein said information towards said user interface is provided on a subscription basis.

13. A computer knowledge system according to claim 11 or 12, wherein said user interface is at least one of a group comprising:
a computer screen;
a mobile telephone;
a pager;
a fax; and
a panel.

14. A computer knowledge system according to claim 13, wherein said user interface forms part of said computer environmnent.

15. A computer knowledge system according to claim 11, 12, 13 or 14, wherein said information towards said user interface is provided if said impact on the operation of said business processes exceeds a predetermined threshold value.

16. A method of providing information about the operation of business processes in a computer environment using a plurality of hardware and software components operatively arranged for enabling a plurality of business processes, said method composes:
collecting data providing information about the operation of said hardware and software components;
storing data providing information about the operation of said business processes and error data relating to erroneous operation of said hardware and software components; and
providing information towards a user interface about the operation of said business processes using said collected and stored data,
said data are processed for providing information towards said user interface about the impact on the operation of said business processes of an erroneous operation of said hardware and software components.

17. A method according to claim 16, further comprising identification of functional transactions within said business processes and dependencies between functional transactions of said business processes, and processing said error data in elation to said functional transactions and their dependencies for providing said information about the impact on said business processes of an erroneous operation of said hardware and software components.

18. A method according to claim 16 or 17, wherein said information indicates at least one of a group comprising:
the extent to which business processes are influenced by a disturbance in said software and hardware components;
the extent to which business processes are influenced by a functional error in said hardware and software components;
the extent to which business processes are influenced by a functional error in said hardware and software components, which functional error cannot directly be monitored;
the extent to which business processes are influenced by an externally applied change, such as a predetermined change for performing impact analyses, in said hardware and software components; and
the extent to which business processes are available in the case of an erroneous operation of said hardware and software components.

19. A method according to claim 16, 17 or 18, further comprising collecting historical data about erroneous operation of said hardware and software components and the impact thereof on said business processes, wherein said information about the impact on said business processes of an erroneous operation of said hardware and software components is provided from processing said historical data.

20. A method according to claim 16, 17, 18 or 19, wherein said information about the impact on said business processes of an erroneous operation of said hardware and software components is provided in terns of at least one of a group comprising:
functionality of the business processes;
usability of the business processes;
maintainability of the business processes;
efficiency of the business processes,
reliability of the business processes; and
changeability of the business processes.

21. A method of alerting about business functions or processes, by providing information in accordance with the method of any of the claims 16, 17, 18, 19 or 20.

22. A method of analyzing the operation of business processes in a computer environment using a plurality of hardware and software components operatively arranged for enabling a plurality of business processes, said method comprises:
collecting data providing information about the operation of said hardware and software components;
storing data providing information about the operation of said business processes and error data relating to erroneous operation of said hardware and software components; and
providing information towards a user interface about the operation of said business processes using said collected and stored data,
said data are processed for providing information towards said user interface about the impact on the operation of said business processes of an erroneous operation of said hardware and software components.

23. A method according to claim 22, further comprising identification of functional transactions within said business processes and dependencies between functional transactions of said business processes, and processing said error data in relation to said functional transactions and their dependencies for providing said information about the impact on said business processes of an erroneous operation of said hardware and software components.

24. A method according to claim 22 or 23, wherein said information indicates at least one of a group comprising:
the extent to which business processes are influenced by a disturbance in said software and hardware components;
the extent to which business processes are influenced by a functional error in said hardware and software components;
the extent to which business processes are influenced by a functional error in said hardware and software components, which functional error cannot directly be monitored;
the extent to which business processes are influenced by an externally applied change, such as a predetermined change for performing impact analyses, in said hardware and software components; and
the extent to which business processes are available in the case of an erroneous operation of said hardware and software components.

25. A method according to claim 22, 23 or 24, further comprising collecting historical data about erroneous operation of said hardware and software components and the impact thereof on said business processes, wherein said information about the impact on said business processes of an erroneous operation of said hardware and software components is provided from processing said historical data.

26. A method according to claim 22, 23, 24 or 25, wherein said information about the impact on said business processes of an erroneous operation of said hardware and software components is provided in terms of at least one of a group comprising:
functionality of the business processes;
usability of the business processes;
maintainability of the business processes;
efficiency of the business processes;
reliability of the business processes; and
changeability of the business processes.

27. A computer program stored on a computer readable medium for use in a computer environment and arranged for operating in accordance with any of the previous claims when compiled on said computer environment.

28. A computer readable medium comprising a computer program for use in a computer environment and arranged for operating in accordance with any of the claims 1-26.
